(19) United States
(12) Patent Application Publication
(10) Pub. No.: US 2020/0409672 A1
(43) Pub. Date: Dec. 31, 2020

(54) CONSTRAINT BASED AUTHORING

(71) Applicant: Kleeen Software, San Jose, CA (US)

(72) Inventors: Joshua HAILPERN, San Jose, CA (US); Aaron GOMEZ, San Jose, CA (US); Jorge RAMIREZ ZAMORA, San Jose, CA (US); Sebastian ALVAREZ, San Jose, CA (US); Mario Octavio JIMENEZ RIVAS, San Jose, CA (US); Edison ROMERO, San Jose, CA (US); Manfred Artavia GOMEZ, San Jose, CA (US); Mainor Gamboa RODRIGUEZ, San Jose, CA (US); Treisy Jimenez VEGA, San Jose, CA (US); Juan Carlos Valerio ARRIETA, San Jose, CA (US); Amy YOSHITSU, San Jose, CA (US)

(21) Appl. No.: 16/455,179

(22) Filed: Jun. 27, 2019

(51) Int. Cl. G06F 8/38; G06F 8/33; G06F 8/20; G06F 8/36

(52) U.S. Cl. CPC G06F 8/38; G06F 8/36; G06F 8/22; G06F 8/33

(57) ABSTRACT

Authoring a user interface for a software product may include soliciting selection of an archetypal task from a creating user, soliciting, according to the selected archetypal task, constraints from the creating user, and generating user interface output files according to the constraints and the selected archetypal task. The user interface output files include mockups, design tool files, code, or combinations thereof. The constraints may include data types corresponding to conceptual objects, purposes of data types, end user goals, end user manipulation preferences, end user priorities. Authoring the user interface may further include suggesting to and eliciting selection by the creating user one or more interaction type.

### BACKGROUND

### 1. Technical Field

The technology described herein relates generally to software development. More particularly, the technology relates to constraint-based generation of computer software components that operate to provide user interface designs and production-ready code.

### 2. Description of the Related Art

Currently, most Enterprise Software-as-a-Service (SaaS) Products are not meeting End-Users' design expectations and usability needs, both of which have increased in recent times. Companies trying to solve this problem may not have the resources (time, talent, funds etc.) to meet these goals, and the results are products whose core values and unique features may be hidden, uninspiring, difficult to access, or more. The overall experience provided through many products' current User Interfaces (UIs) are neither enjoyable nor engaging. Design and Development teams may be locked into ultimately unproductive cycles due to technical debt and trying to provide band-aids instead of holistic solutions to problems.

Design teams may include User Experience (UX) designers who determine the processes by which an End-User interacts with the UI to accomplish tasks; and UI or Visual designers who determine the size, shapes, colors, and other graphical properties of the UI elements with which the End-User interacts. Development teams include software engineers who write the computer software components that provide the UI and accomplish the UX tasks specified by the Design team. A Product Manager is often present as well, specifying the business needs that a new feature or product must satisfy. Other input may come from back-end engineers and/or data scientists who convey both what the underlying computer system can accomplish and the data (and data format) currently stored. Traditionally, the back-end engineers or data scientists provide the initial information such that the UI and UX reflect the back-end architecture, rather than a End-User-focused design based on collaboration between the multiple teams.

In-house and manual approaches to UI development may involve a chain of assumptions, personal biases, and mis-communications between teams. Often, a large or small product goal is driven by an individual or team who believes their goal may be achieved either by methods that are commonly used on the marketplace or methods driven by the creators' biases and unsubstantiated assumptions about End-Users. This may set the stage for a product whose proposed solutions will not adequately address the needs of End-Users.

This initial problem is often conveyed to the Design Team in the language of the assumed solution. Unfortunately, the Design Team (no matter the talent level) may not have the resources to complete a proper R&D phase in order to validate the assumptions driving the in-progress solutions. The solution mockups, often manually made by the Designers, are therefore inevitably embedded with false assumptions. These solution mockups are then handed-off to the Development Team.

Not only is the interpretation of the Design by the Development team a challenge, it is often the case that the Development team cannot implement the design within the timeframe required with the resources available. This leads to cycles of concept, design and development iterations that produce a product optimized for the teams' needs and resources, and not for the End-Users' experiences. Further compounding this problem are requirements by the Product Manager (usually informed by the back-end engineer), who changes goals or requirements too late in the production cycle, leading to major revisions.

One approach to producing interfaces is What You See Is What You Get (WYSIWYG) tools. WYSIWYG tools allow non-Designers to create product interfaces. The advantages of the WYSIWYG approach include that the individual visual components are consistent in style and micro-behavior, and the visual components are automatically converted into code.

The virtues of this approach are finite and limited when it comes to providing the best solutions for the End—Users' needs and problems. The creation of the whole interface and the UX is still dependent on the creator's knowledge of the End-User and product sector, visual skill, usability knowledge, and knowledge of best practices in UI and UX design. As a result, the addition of WYSIWYG tools may not significantly improve productivity compared to the manual method and may even hinder the process since there are limited components available.

There are many potential disadvantages to using WYSIWYG tools. The creator using the tools may falsely assume consistency is baked into the system, when actually it is dependent on the creator to use the components in a consistent and usable manner and to build usable tasks and patterns. Inconsistencies may also be introduced when there are multiple creators due to inadequate documentation or coordination; when creators wish to leave their mark on the product, and when creators engage and disengage with a project at different stages of development. WYSIWYG does not provide any guidance as to how to use a component for each unique requirement.

Furthermore, most WYSIWYG systems provide one component/solution per class of issues, and as a result, specific nuanced requirements and context cannot be addressed. Also, the code created by WYSIWYG may be a patchwork of non-scalable code snippets and may not be enterprise-grade. Finally, in most systems, a preview of the product depends on the creators having mid-to-high technical knowledge because the backend portion of the system needs to be manually connected to the code generated by the WYSIWYG tools.

Another approach is to use templates. Compared to the WYSIWYG approach, templates are even more limiting as they are made of larger, more rigid components. The creators are forced to select a template that is the “best fit” for a mid-to-large problem but does not actually provide a path towards the best solution. No longer is the issue that the system does not provide guidance for best practices and usability, but, instead, no matter how much knowledge a creating team has, templates cannot properly address the individual UI/UX needs of each product. And, like WYSIWYG, the resulting code is often neither scalable nor enterprise-grade.

Therefore, a need exists for a process that produces enterprise-grade user interfaces that provide a good user experience, and that does so more quickly, with fewer resources, and in a manner that is scalable.

### SUMMARY

In an embodiment, a method of authoring a user interface for a software product comprises soliciting selection of an archetypal task from a creating user, soliciting, according to the selected archetypal task, constraints from the creating user, and generating user interface output files according to the constraints and the selected archetypal task.

In another embodiment, a non-transitory computer readable media comprises computer programming instructions. When the computer programming instructions are executed by a computer, they cause the computer to solicit selection of an archetypal task from a creating user, solicit, according to the selected archetypal task, constraints from the creating user. and generating user interface output files according to the constraints and the selected archetypal task.

User interface output files may include mockups, design tool files, code, or combinations thereof.

### BRIEF DESCRIPTION OF THE DRAWINGS

FIG. 1 illustrates an End-Product produced according to an embodiment.

FIG. 2 illustrates a constraint-based software authoring system according to an embodiment.

FIG. 3 illustrates a constraint-based software authoring process according to an embodiment.

### DETAILED DESCRIPTION

Embodiments relate to software development. In particular, embodiments relate to tools that automate portions of the production of User Interface (UI) design, code, or both, including designs and/or code related to navigation, theming, search, and internationalization, by producing design files and/or code based on creator-supplied input such as end-user goals, data constraints, and selections among available options. Based on these inputs, the technology produces theoretically-grounded UI recommendations and full or partial implementations.

In embodiments, a constraint-based software authoring system (herein after, the authoring system) interacts with a Creating-User to develop a set of constraints regarding an End-Product to be created by the authoring system.

The constraints may include properties of conceptual objects that are pertinent to the End-Product (such conceptual objects including, for example, a person, product, context component, abstract concept, and so on). The constraints on the conceptual objects may be used to select data types that represent the objects.

The constraints may also include properties of goals of End-Users of a Task of the End-Product. These goals may include an expected class of outputs and constraints on how the outputs of the End-Product are presented.

From the constraints, the authoring system may determine a plurality of candidate workflows (each corresponding to one or more tasks) by which the End-User may accomplish their goals, and may rate the candidate workflows according to criteria related to the usability of the workflow. The criteria may take into account, for example, level of consistency, potential cognitive load required, and the like. The Creating-User may then select a workflow solution design (from a set of candidate workflow solution designs) for inclusion in the End-Product, and may use the ratings of the candidate solutions when doing so. These solutions can be tried or demoed by interacting with a production-code version of the design, on demand.

From the constraints, the authoring system may determine a plurality of candidate UI styles, and may rate the candidate UI styles (including palettes, flavors, etcetera) according to various usability criteria. The criteria may be based on, for example, level of consistency, potential cognitive load required, uniqueness in a field/discipline, and the like. The criteria may take into account, for example, suitability to a particular group of End-Users, such as suitability according to an age, a level of education, or specific knowledge of the End-User. The UI styles may also be rated according to their suitability to selected workflows. The Creating-User may then select one or more UI styles for use in the End-Product, and may do so using the ratings for the candidate UI styles.

Workflows and/or UI styles selected by the Creating-User are used by the authoring system to generate computer programs and/or mockups for a user interface.

By this process, the authoring system may allow a Creating-User who is not skilled in the creation of UIs but has a good understanding of the End-User, the problems faced by the End-User, and/or the goals of the End-User to create a good UI for accomplishing the goals of the End-User. Furthermore, the authoring tool may provide suggestions that even a skilled UI creator might have overlooked, and may help to educate the Creating-User in the best practices of User Experience (UX) design.

In embodiments, the authoring system may focus on the production of computer programs that provide necessary and ubiquitous aspects of a certain class of software products (for example, Software-as-a-Service products). Such aspects may include infrastructure (Navigation, Theming—style and components) and archetypes (Configuration—editing details of data and information; Dashboards—pages and tasks that display information; Investigations—pages and tasks that allow End-Users to find and solve a problem, etc.).

In the following detailed description, certain illustrative embodiments have been illustrated and described. As those skilled in the art would realize, these embodiments are capable of modification in various different ways without departing from the scope of the present disclosure. Accordingly, the drawings and description are to be regarded as illustrative in nature and not restrictive. Like reference numerals designate like elements in the specification.

Embodiments relate to the generation of UIs that provide a UX. The lowest (simplest) elements of the UI may be termed atoms (e.g., form fields, buttons, visualization, or text). Atoms may be combined with properties, logic, and functionality to form molecules (e.g., a search box, check-box list, or menu). Molecules may be combined to create an organism corresponding to a relatively complex, distinct section of the UI (e.g. a navigation header, filter panel, or gallery layout). Multiple organisms may be combined to resolve a task corresponding to an archetypal flow of an end user (e.g., performing monitoring, triage, configuration, or editing). The UI may be composed of one or more pages each corresponding to an instance of a task and using specific organisms with specific data (e.g., a product's portal or dashboard).

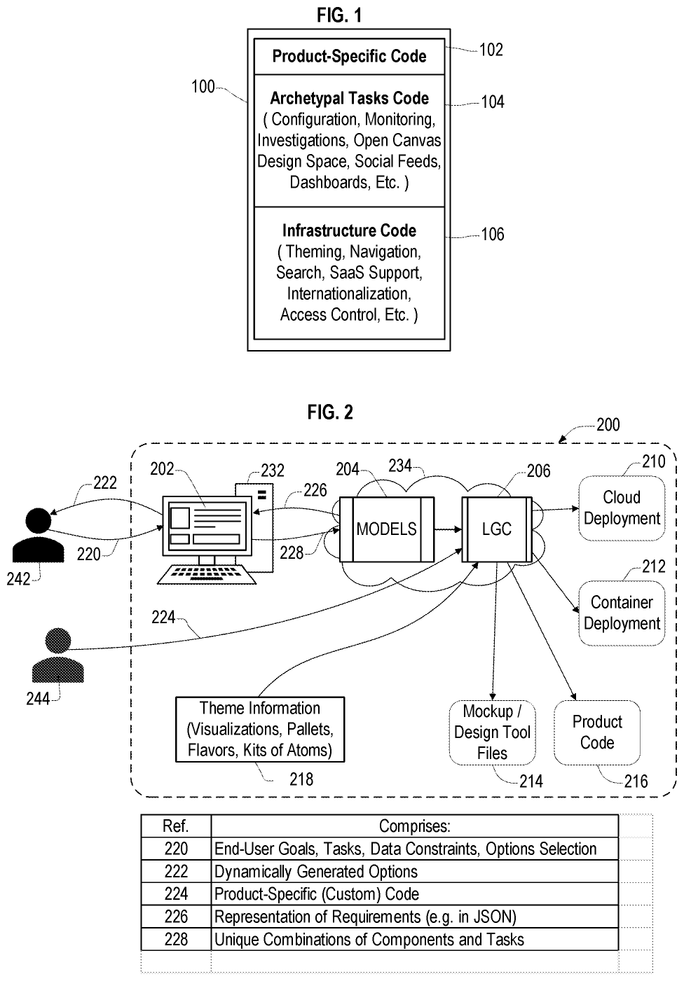

FIG. 1 illustrates an End-Product 100 produced according to an embodiment. The End-Product 100 includes Archetypal Tasks Code 104 that may provide the End-User with workflows or tasks for Configuration, Monitoring, Investigations, Open Canvas Design Space (e.g. for data visualization), Social Feeds, Dashboards, and the like. The End-Product 100 may further include Infrastructure Code 106 for performing Theming, Navigation, Search, SaaS Support, Internationalization, Access Control, and the like. The End-Product 100 may also include product-specific components 102 for performing functions that may be specific or unique to the End-Product 100.

FIG. 2 illustrates a constraint-based software authoring system 200 according to an embodiment. In the embodiment of FIG. 2, the authoring system 200 includes a picker 202 being provided using a workstation computer 232, and a modeling system 204 and logic conversion system 206 being provided using a cloud server 234, but embodiments are not limited thereto. The authoring system 200 may be used to produce a User Interface for an end product such as the End-Product 100 of FIG. 1.

The picker 202 interacts with a Creating-User 242. The picker 202 provides prompts to and receives inputs 220 from the Creating-User 242. The inputs 220 may include End-User goals, data constraints, and selections from options presented by the picker 202 to the Creating-User 242. The inputs may include selections from a menu or natural language input.

Illustrative End-User goals may include identifying outliers in a dataset, comparing and contrasting different portions of a dataset, being able to browse all the points in the dataset, detecting general trends in a dataset, and the like. An End-User may have multiple such goals for the End-Product.

In an embodiment, inputs received by the picker 202 from the Creating-User 242 may include indication of one or more types of tasks the End-Product will support and that are best for the End-User. Example types of tasks include dashboards, profiles, news/social feeds, investigations, and so on. Determining these tasks may be the initial step in using the authoring system 200. The authoring system 200 may then guide the Creating-User 242 through all the implications of these task choices and capture constraints so that the Creating-User 242 can choose the best layout and UX options within an Archetype solution.

In an embodiment, inputs received by the picker 202 from the Creating-User 242 may include information on one or more objects, relationships between the objects, and actions that may be performed on the object. When any creating team is conceptualizing a new End-Product or augmenting an existing End-Product, the Objects and the End-Users' goals may drive the design. The End-Users' goals imply a task or operation and the combination of Objects and Operations are the conceptual elements of a Task. This may be known as an object-first approach.

The authoring system 200 may determine types of tasks that make up the End-Product according to constraints at the Object/Operation level and by the holistic goals and habits of the End User.

The picker 202 may process the inputs 220 using any or all of pre-coded decision trees, artificial intelligence, machine learning, probabilistic modelling, or rule mining to analyze the inputs 220. Based on this analysis, the picker 202 may elicit additional information from the Creating-User 242.

For example, if the Creating-User 242 indicates that the End-Product is an e-commerce site, the picker 202 may present the Creating-User 242 with questions related to e-commerce sites or to make selections from among options related to e-commerce sites. If the Creating-User 242 indicates that the End-Product is a “medical records” app, the authoring system 200 may select appropriate objects and tasks (in an embodiment, subject to the Creating-User's confirmation of the choices made by authoring system 200) and may also add, for example, navigation-related constraints as discussed below.

The picker 202 may use each new input from the Creating-User 242 to determine additional queries. An End-User having a particular constraint may limit the set of options that the Creating-User 242 is allowed to select from.

The picker 202 may also solicit the Creating-User 242 to pick a Flavor for the User Interface. A Flavor may include a collection of shapes, fonts, animations, and the like that give a user interface a distinctive feel and that may include or be combined with a palette of colors. Some examples of possible Flavors include Futuristic, Minimal, Corporate, etc. Each choice provides additional non-semantic styling to all UI Components such that the look and feel of the End-Product can align with the Creating-User's branding message and easily situate an End-Product in a mental category of the End-User.

The picker 202 may also solicit information from the Creating-User 242 about any product-specific components 224 that will be incorporated into the End-Product. The product-specific components 224 may include custom pages, custom workflows, custom functional codes, or combinations thereof. The authoring system 2300 then creates a skeleton (that is, an interface specification akin to a “.h” file in the C programming language or an abstract class in Java) to allow that authoring system to incorporate the product-specific components 224 into the output of the authoring system 200.

The picker 202 may also receive navigation-related constraints from the Creating-User 242. Navigational constraints can include notification requirements for events, confirmation requirements for commands, the number of accounts one End-User can access in the interface at a time, and so on. The picker 202 may also elicit from the Creating-User 242 information about the importance and desired prominence of each Task in the End-Product (and the associated data types and goals).

In response to the received navigation-related constraints, the importance and desired prominence of each task, and the other constraints provided by the Creative-User 242, the picker 202 may determine one or more suggested navigation approaches and present the suggestions to the Creative-User 242. The Creative-User 242 may then indicate a selected navigation approach or approaches to the picker 202. Based on the received navigation-related constraints, the suggested navigation approaches may include specific high-level functionality, such as a notification alert button or an account picker.

Based on the selected navigation approach(es), the navigation-related constraints, the pages created, and/or the actual content of the pages, the authoring system 200 creates a navigation infrastructure including layouts and methods.

Based on the inputs 222, the picker 202 communicates a representation of requirements 226 for the End-Product to the modeling system 204. The representation of the requirements may be, for example, in JavaScript Object Notation (JSON).

The modeling system 204 includes one or more predictive models that, based on the representation of requirements 226, produce a plurality of options 208. Each option may be a unique combination of components and workflows, and each may be given a score the indicates the usability of that option. The usability may be determined by each combination's level of consistency, potential cognitive load required, and so on.

In an embodiment, each organism may have PROS, CONS and REJECTION information that may be used to determine the usability score. For example, a certain filter design (e.g. amazon's check boxes on the left side) may be optimal for certain situations indicated in the filter's PROS information, may have some draw backs for certain situations indicated in its CONS information, and may be inappropriate (and therefore should never be used) for situations indicated in its REJECTION information. To satisfy any given user need (such as filtering) the authoring system 200 may have many organisms in a “class” that are available to satisfy that need, and every TASK will have many “classes” of organisms where one of each is needed. The authoring system may evaluate through every permutation (not combination) of one from every class and determine the aggregate usability score. Some permutations may be rejected because one or more of the organisms therein violate a user's goal for the task (e.g. user input) as indicated by that goal being in the REJECTION information of the one or more of the organisms. Then a usability score for each permutation may the determined by, for example, adding 1 whenever a current situation is indicated in the PROS information of an organism of the permutation and subtracting 1 whenever a current situation is indicated in the CONS information of an organism of the permutation.

Each option may be accompanied by not only a usability score, but also an explanation of which End-User needs that option may address, why that option might be the most responsive way to address the End-User's needs, or both.

The modeling system 204 communicates the plurality of options to the picker 202. The Picker 202 may then present the options with their usability scores and explanations, if present, to the Creating-User 242. The picker 202 may then solicit a selection of one or more of the options. In some cases, the selection of one of the options may result in the picker 202 soliciting more information from the Creating-User 242 in order to further refine the constraints.

Once the above process is complete, the selected combination of components and workflows, along with information and constraints from the picker 202, are provided to the logic conversion system 206. The logic conversion system 206 may use these components, workflows, constraints and other information, along with along with product-specific components 224 if present, to produce one or more mockups/design tool files 214 representing the user interface of the End-Product.

The logic conversion system 206 may also use palettes, flavors, kits, and visualizations from one or more theme information sources 218 to create the one or more mockups/design tool files 214. The theme information files 218 may include information defining graphic elements, code to perform actions (such as drawing, activating, and deactivating) associated with the graphic elements, parameters to use when performing those actions, or combinations thereof. Theme information files may be selected by the Creating-User 242.

Palettes in the theme information files 218 take in constraints of brand colors and the importance of colors, and generate groups of colors (primary, secondary, neutral, supporting, etcetera) where the importance of the color is valued, and does not have a semantic use in the product produced by the authoring system 200. The Creating-User 242 is therefore free to choose a palette according to their own criteria.

Flavors in the theme information files 218 take in stylistic goals (e.g. flat, modern, futuristic, corporate) and include information used to generate styling of a product (e.g. drop shadows, glows). Flavors may also specify how to use one or more of the palette colors (e.g. applying a semantic use case like “hover color” or “link color” to a specific palette color).

Visualizations in the theme information files 218 follow a similar logic and correspond to classes of ways to style and design visualizations. For example, there are many ways to design a bar chart, a pie chart, or a scatter chart, and a theme may include respective visualization for each such chart, all with a common stylistic feelings that may be specific to that theme.

Kits in the theme information files 218 are comprised of low level atoms (the basic unit of UI, such as a form field, or a button), and define the way those atoms look and function in the theme, i.e., a “design language.” In each kit, all the atoms follow the same design language. The atoms in kits may also include shared logic. The shared logic of a selected kit may be imparted into every other selected kits. For example, a kit may include logic for a user tracking feature that would then by inherited by all the other kits. The shared logic may reference internal code that is not public.

Theme information files may also include visualization kits, wherein in each visualization kit, a plurality of visualizations share a design language (e.g., a flat design language, a 3D design language, and so on.) Each visualization may be treated like an atom by the Creating-User. Like the kits of atoms, kits of visualizations may include shared logic. Visualization kits may inherit shared logic from atom kits, and vice versa. The shared logic may reference internal code that is not public.

Kits may also be sandboxed for security. This prevents the author of a kit from intentionally or unintentionally creating a security vulnerability in the product.

Kits can be baked into a product. They can be created to be completely internal to a customer, or may be shared or licensed via a marketplace.

The logic conversion system 206 uses on the atoms to generate many elements of the mockups/design tool files 214. Atoms are abstract representations of the UI element they represent. In embodiments, an atom exports itself into the mockup/design tool files 214 as an image (e.g., svg, png, etc.), as code (e.g., react, angular, vuejs, etc.), or as combinations thereof, and the authoring system 200 provides the higher level logic. The code and images are to a large extent automatically correct as they are a product of the atoms exporting themselves, and take in the palette, flavors, etcetera.

The mockup/design tool files 214 may include one or more high-quality mockups (in, for example, Portable Network Graphics (PNG), Joint Picture Expert Group (JPEG), or Scalable Vector Graphic (SVG) format), one or more editable design tool files (for example, Sketch or Adobe Illustrator® files), or both. The mockup/design tool files 214 are based on design decisions, components, pages and so on, and may be used for internal design, future work, etcetera. They may be produced based on the selections of the Creating-User 242 regarding preferred UI component system types, colors, fonts, Flavors (described above), non-semantic styling preferences, and the anticipated sizes of screens on which the End-User will view the End-Product. Further development of the End-Product may be commenced based on the sketch files 214.

In embodiments, the authoring system 200 may also produce pixel-accurate mockups of the End-Product, including every screen of every page and task, using the UI components expressed in the mockup/design tool files 214. The Creating-User 242 may have access to all the UI components (and, in embodiments, the corresponding scalable code) expressed in the mockup/design tool files 214, and may use them when generating custom pages so that consistency may be maintained between the portions of the End-Product produced by the authoring system 200 and the portions custom-created by the Creating-User 242 or Designer 244.

The logic conversion system 206 may also use the components, workflows, constraints and other information along with (optionally) product-specific components 224 to produce finished End-Product software, such as stand-alone product code 216, a container deployment 212 (i.e., a package of code, configurations, and dependencies), and/or a cloud deployment 210 (such as for Amazon Web Services (AWS), Google Cloud, Microsoft Azure, or the like). The Designer 244 of the product-specific components 224 may be the same person or team as the Creating-User 242, or may be a different person or team. The product-specific components 224 may be developed using a Software Development Kit (SDK) associated with the authoring system 200.

Any one of the Mockup/Design Tool Files 214, stand-alone product code 216, container deployment 212, cloud deployment 210, or combinations thereof may correspond to the End-Product.

The outputs of the logic conversion system 206 may be created from carefully crafted libraries produced by the analysis of UIs that provide good UX, and specifically on analysis that focuses on the uses and meanings of layout, styling, and micro-behavior per component type. Accordingly, a UI produced using the authoring system 200 may intentionally use a specifically-styled button for a specific situation and context, for example, when an End-User is faced with a choice in a specific context, such as an action being primary but in the disabled state. Pairing an intentionally-styled component to the same state or function in all use cases yields high consistency and usability. Additionally, populating End-Products with components derived from the analysis of widely-established systems results in the End-Product having usage patterns and interactions that are already familiar to many End-Users, thus decreasing the potential learning curve and increasing the usability of the End-Product.

By using the constraint-based authoring system 200, the Creating-User 242 may produce a design and Enterprise-grade code based on the Creating-User's knowledge. While the specific information of each End-Product is unique to the data it features, that information is finite. Accordingly, constraint-based authoring system 200 may unburden creators from spending unnecessary time and energy attempting to reinvent solutions to common or predictable End-Product requirements, provide a known-best-practices solution to the requirements, and allow creators to spend more time and focus creativity on the high-value and unique features of their End-Product, such as may be provided via the product-specific components 224.

The authoring system 200 serves to decrease the time and effort placed into the development of “standard” aspects of an End-Product, and therefore increase the opportunity for Creating-Users' talents to highlight the value proposition of the End-Product. A Creating-User is allowed and encouraged to include Custom pages and tasks and Custom areas within the pages/tasks into the End-Product. Additionally, by allowing the Creating-User to access UI Components (and their code) that may be usable for the custom functionality, the authoring system 200 may make once-tedious aspects of design and development more efficient, thereby providing more resources for creative opportunities and envelope-pushing.

The authoring system 200 can connecting the End-User's web, social, and product interactions into one seamless experience.

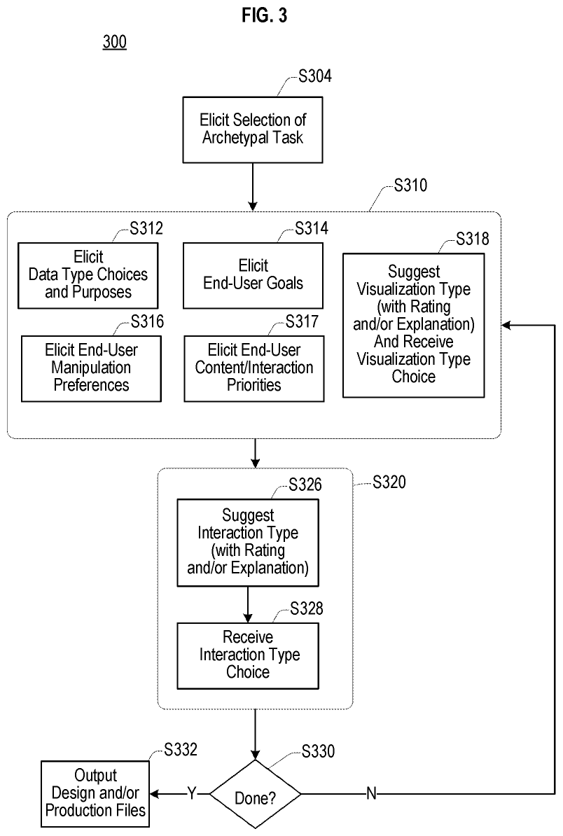

FIG. 3 illustrates a process 300 for performing constraint-based software authoring, and in particular for constraint-based authoring of a task, according to an embodiment. The process 300 may be performed by one or more of the computer 232 and/or cloud server(s) 234 shown in FIG. 2 and may produce an End-Product such as the End-Product 100 shown in FIG. 1.

A first phase S304 of the process 300 elicits selection of an archetypal task. For example, the archetypal task may be elicited using a list of available archetypal tasks, or using a natural language query, but embodiments are not limited thereto.

A second phase S310 of the process 300 solicits, based on the selected archetypal task, constraints and other information regarding the End-Product and the End-User who will use the End-Product. Elements of the first phase S310 may be performed in any order, and may be performed repeatedly. Each element of the first phase S310 may be performed zero or more times. The elicitations performed in the first phase S310 may be performed using spoken or written natural language, selection from a list of available or suggested options, and the like. Each elicitation may be performed according to previous information provided to the process 300.

At S312, the process 300 elicits data type choices from a Creating-User, and may do so in light of previous information provided to the process 300. For example, a list of available data types may be tailored to an application type or archetypal task previously selected by the Creating-User. At S312, the process 300 may also elicit the purpose of the data being represented by the data type, that is, why the user is interested in the data. For example, the task being authored may seek to identify outliers of the data represented by the data type.

At S314, the process 300 elicits End-User goals from the Creating-User. The End-User goals may be at a very high level (e.g. “manage medical records,” “conduct e-commerce”) or more specific (e.g., “identify outliers in datasets,” “identify trends”).

At S316, the process 300 elicits End-User manipulation preferences. Manipulation preferences may include general preferences (e.g. graphical manipulation versus text editing) or specific manipulation paradigms the End-User prefers (e.g., check boxes, radio buttons, sliders, spinners, interactive canvases, etcetera). Embodiments may allow manipulation preferences to be specified generally according to a data type, a purpose of data, or combinations thereof.

At S317, the process 300 elicits End-User content/interaction priorities from the Creating-User, in accordance with, for example, which data or interactions the End-User will consider most important, perform most often, input or modify most often, and the like.

At S318, the process 300 may optionally suggest one or more visualization types to the Creating-User. Each suggested visualization type may be accompanied by a usability rating, an explanation of why it may be appropriate to the End-Product being authored, or both. Visualization types may include graphs, maps, tables, and the like, including specific types of visualization tailored to the constraints (such as data types, data purposes, goals, and manipulation preferences) previously received by the process 300. Suggested visualizations may include dials, gages, heat maps, line graphs, bar graphs, timelines, etcetera, or combinations thereof).

The process 300 may then receive at least one choice of visualization type selected from one or more visualization types by the Creating-User. In an embodiment, the Creating-User may decline to choose any of the suggested one or more visualization types. The information that the Creating-User found all of the suggested one or more visualization types unacceptable may be used by the process 300 to determine and present additional suggested visualization types different from those previously presented.

A third phase S320 of the process 300 may follow the first phase 310 and may be based upon the information previously acquired by the process 300.

At S326, the process 300 suggests one or more holistic interaction types to the Creating-User. Each suggested holistic interaction type may be accompanied by a usability rating (e.g., a usability score), an explanation of why it may be appropriate to the End-Product being authored, or both.

At S328, the process 300 receives at least one choice of interaction type selected from one or more visualization types by the Creating-User. In an embodiment, the Creating-User may decline to choose any of the one or more suggested holistic interaction types. The information that the Creating-User found all of the suggested one or more interaction types unacceptable may be used by the process 300 to determine and present additional suggested interaction types different from those previously presented.

The process 300 may repeatedly perform S326 and S328.

At S330, the process 300 determines whether the Creating-User is finished with providing constraints and other information to the process 300. If the Creating-User is done, then at S330 the process 300 proceeds to S332; otherwise at S330 the process 300 may proceed to S310 to acquire additional information from the Creating-User.

At S332 the process 300 outputs one or more sets of design files, production files, or combinations thereof, according to the information collected at earlier stages of the process 300. The design files may include a Sketch file, a Portable Document Format (PDF) file, a Word document, a PowerPoint document, or the like. The production files may include product code (e.g., computer programs in C, C++, Java, Python, JavaScript, or the like), a container deployment, a cloud deployment, or combinations thereof.

Embodiments of the present disclosure include electronic devices configured to perform one or more of the operations described herein. However, embodiments are not limited thereto. Embodiments of the present disclosure may further include systems configured to operate using the processes described herein.

Embodiments of the present disclosure may be implemented in the form of program instructions executable through various computer means, such as a processor or microcontroller, and recorded in a non-transitory computer-readable medium. The non-transitory computer-readable medium may include one or more of program instructions, data files, data structures, and so on. The program instructions may be adapted to execute the processes described herein.

In an embodiment, the non-transitory computer-readable medium may include a read only memory (ROM), a random access memory (RAM), or a flash memory. In an embodiment, the non-transitory computer-readable medium may include a magnetic, optical, or magneto-optical disc such as a hard disk drive, a floppy disc, a CD-ROM, and the like.

In some cases, an embodiment of the invention may be an apparatus that includes one or more hardware and software logic structure for performing one or more of the operations described herein. For example, as described above, the apparatus may include a memory unit, which stores instructions that may be executed by a hardware processor installed in the apparatus. The apparatus may also include one or more other hardware or software elements, including a network interface, a display device, etc.

While this invention has been described in connection with what is presently considered to be practical embodiments, embodiments are not limited to the disclosed embodiments, but, on the contrary, may include various modifications and equivalent arrangements included within the spirit and scope of the appended claims. The order of operations described in a process is illustrative and some operations may be re-ordered. Further, two or more embodiments may be combined.

What is claimed is:

1. A method of authoring a user interface for a software product, the method comprising:
soliciting selection of an archetypal task from a creating user;
soliciting, according to the selected archetypal task, constraints from the creating user; and
generating user interface output files according to the constraints and the selected archetypal task.

2. The method of claim 1, wherein the user interface output files include mockups, design tool files, code, or combinations thereof.

3. The method of claim 1, wherein soliciting constraints from the creating user includes eliciting constraints according to previously solicited constraints.

4. The method of claim 1, wherein soliciting constraints from the creating user include eliciting the selection of a data type corresponding to conceptual objects pertinent to the software product.

5. The method of claim 4, wherein soliciting constraints from the creating user include eliciting a purpose of the selected data type.

6. The method of claim 5, wherein soliciting constraints from the creating user include eliciting end user manipulation preferences for the selected data type or the elicited purpose of the data type.

7. The method of claim 1, wherein soliciting constraints from the creating user include eliciting end user goals for the software product, the selected archetypal task, or both.

8. The method of claim 1, wherein soliciting constraints from the creating user include eliciting end-user priorities for content, interactions, or both of the software product, the selected archetypal task, or both.

9. The method of claim 1, further comprising:
suggesting, to the creating user, one or more interaction types according to the solicited constraints;
eliciting the selection of an interaction type from among the suggested one or more interaction type by the creating user; and
generating the user interface output files according to the selected interaction type.

10. The method of claim 9, wherein suggesting, to the creating user, the one or more interaction types includes providing one or more respective usability scores of the one more interaction types to the creating user.

11. The method of claim 1, further comprising:
receiving, from the creating user, a selection of a theme, the selected theme comprising on or more palettes, flavors, kits of atoms, visualizations, kits of visualizations, or combinations thereof; and
generating the user interface output files the according to the selected theme.

12. A non-transitory computer readable media comprising computer programming instructions that when executed cause a computer to perform:
soliciting selection of an archetypal task from a creating user;
soliciting, according to the selected archetypal task, constraints from the creating user; and
generating user interface output files according to the constraints and the selected archetypal task.

13. The non-transitory computer readable media of claim 12, wherein the user interface output files include mockups, design tool files, code, or combinations thereof.

14. The non-transitory computer readable media of claim 12, wherein soliciting constraints from the creating user includes eliciting constraints according to previously solicited constraints.

15. The non-transitory computer readable media of claim 12, wherein soliciting constraints from the creating user include eliciting the selection of a data type corresponding to conceptual objects pertinent to the software product.

16. The non-transitory computer readable media of claim 15, wherein soliciting constraints from the creating user include eliciting a purpose of the selected data type.

17. The non-transitory computer readable media of claim 12, wherein soliciting constraints from the creating user include eliciting end user goals for the software product, the selected archetypal task, or both.

18. The non-transitory computer readable media of claim 12, wherein soliciting constraints from the creating user include eliciting end-user priorities for content, interactions, or both of the software product, the selected archetypal task, or both.

19. The non-transitory computer readable media of claim 12, further comprising computer programming instructions that when executed cause the computer to perform:
suggesting, to the creating user, one or more interaction types according to the solicited constraints, suggesting the one or more interaction types including providing one or more respective usability scores of the one more interaction types to the creating user;
eliciting the selection of an interaction type from among the suggested one or more interaction type by the creating user; and
generating the user interface output files according to the selected interaction type.

20. The non-transitory computer readable media of claim 12, further comprising computer programming instructions that when executed cause the computer to perform:
receiving, from the creating user, a selection of a theme, the selected theme comprising on or more palettes, flavors, kits of atoms, visualizations, kits of visualizations, or combinations thereof; and
generating the user interface output files the according to the selected theme.
